(19) United States
(12) Patent Application Publication
(10) Pub. No.: US 2010/0137135 A1
(43) Pub. Date: Jun. 3, 2010

(54) HERBICIDE COMBINATIONS COMPRISING DIFLUFENICAN AND ALS INHIBITORS

(75) Inventor: Victor Jose MARCELES PALMA, Dusseldorf (DE)

Correspondence Address: Baker Donelson Bearman, Caldwell & Berkowitz, PC, 555 Eleventh Street, NW, Sixth Floor, Washington, DC, 20004, US

(73) Assignee: BAYER CROPSCIENCE AG, Monheim (DE)

(21) Appl. No.: 12/622,517

(22) Filed: Nov. 20, 2009

(30) Foreign Application Priority Data
Nov. 22, 2008 (DE) 102008058642.0

(51) Int. Cl. A01N 25/32; A01N 43/40; A01P 13/00

(52) U.S. Cl. 504/103; 504/130

(57) ABSTRACT

Herbicide combinations with an effective content of diflufenican and a herbicide from the group consisting of metsulfuron-methyl, thifensulfuron-methyl and tribenuron-methyl.

These herbicidal compositions have improved herbicidal effects.

The invention is in the technical field of crop protection compositions which can be used against harmful plants, e.g. in plant crops, and comprise, as active ingredients, a combination of diflufenican and a further herbicide.

The herbicidal active ingredient diflufenican is preferably used post-emergence against a number of harmful plants in cereal crops, such as, for example, wheat and barley. However, the efficacy of diflufenican against harmful plants in these cereal crops is not always satisfactory.

One option for improving the application profile of a herbicide can consist in combining the active ingredient with one or more other active ingredients. However, in the case of the combined application of two or more active ingredients, phenomena of physical and biological incompatibility arise not infrequently, e.g. lack of stability in a coformulation, decomposition of an active ingredient or antagonism of the active ingredients. By contrast, combinations of active ingredients with a favorable efficacy profile, high stability and the greatest possible synergistically enhanced effect, which permits the application rate to be reduced compared to the individual application of the active ingredients to be combined, are desired.

Thus, EP 1 053 679 B1 discloses the mixture of diflufenican with flupyrsulfuron-methyl. DE 19834629 discloses a large number of mixtures comprising diflufenican and at least one further herbicide. It also mentions the mixtures comprising

a) diflufenican, metsulfuron-methyl and triasulfuron,
b) diflufenican, metsulfuron-methyl and prosulfuron,
c) diflufenican, thifensulfuron-methyl and triasulfuron,
d) diflufenican, thifensulfuron-methyl and prosulfuron,
e) diflufenican, tribenuron-methyl and triasulfuron, and
f) diflufenican, tribenuron-methyl and prosulfuron.

However, the mixtures comprising diflufenican that are known from the prior art do not always meet the set requirements.

It was an object of the present invention to improve the application profile of the herbicidal active ingredient diflufenican.

This object has been achieved through the provision of herbicide combinations comprising, as sole herbicidal active ingredients, diflufenican and a further active ingredient from the group consisting of metsulfuron-methyl, thifensulfuron-methyl and tribenuron-methyl.

The invention therefore provides herbicide combinations comprising, as sole herbicidal active ingredients,

A) diflufenican (component A), and
B) a herbicide from the group consisting of metsulfuron-methyl, thifensulfuron-methyl and tribenuron-methyl (component B).

The active ingredients specified in this description by their “common name” are known, for example, from “The Pesticide Manual”, 14th Ed., British Crop Protection Council 2006 and the website “http://www.alanwood.net/pesticides/”.

If, within the context of this description, the short form of the “common name” of an active ingredient is used, then in each case all customary derivatives, such as the esters and salts, and isomers, in particular optical isomers, are encompassed, especially the commercially available form or forms. If the “common name” is used to refer to an ester or salt, then this also in each case encompasses all other customary derivatives such as other esters and salts, the free acids and neutral compounds, and isomers, especially optical isomers, in particular the standard commercial form or forms. The stated chemical compound names refer to at least one of the compounds encompassed by the “common name”, often a preferred compound.

The herbicide combinations according to the invention have a herbicidally effective content of component A) and component B) and can comprise further constituents, e.g. agrochemical active ingredients from the group of insecticides, fungicides and safeners and/or additives and/or formulation auxiliaries that are customary in crop protection, or can be used together with these.

In a preferred embodiment, the herbicide combinations according to the invention have synergistic effects. The synergistic effects can be observed, for example, upon joint application of components A and B, although they can often also be found in the case of staggered application (splitting). Application of the individual herbicides or of the herbicide combinations in several portions (sequential application), e.g. pre-emergence applications, followed by post-emergence applications or early post-emergence applications, followed by medium or late post-emergence applications, is also possible. Preference is given here to the joint or almost simultaneous application of the active ingredients of the herbicidal compositions according to the invention.

The synergistic effects permit a reduction in the application rates of the individual active ingredients, a higher effectiveness for the same application rate, the control of species that have hitherto not been controlled (gaps), an extension of the application period and/or a reduction in the number of required individual applications and—as a result for the user—economically and ecologically more advantageous weed control systems.

The herbicide combinations according to the invention encompass the combinations of

a) diflufenican and metsulfuron-methyl,
b) diflufenican and thifensulfuron-methyl and
c) diflufenican and tribenuron-methyl.

The application rate of components A and B and salts thereof can vary within wide ranges, for example in each case between 5 and 500 g of AS/ha. Wherever the abbreviation AS/ha is used in this description, this means “active substance per hectare”, based on 100% strength active ingredient. For applications with application rates of from 5 to 500 AS/ha of components A and B and salts thereof, a relatively broad spectrum of annual and perennial weeds, weed grasses and Cyperaceae is controlled in the pre- and post-emergence method. In the case of the herbicidal compositions according to the invention, the application rates are generally lower, e.g. in the range from 50 to 500 g of AS/ha, preferably 50 to 250 g of AS/ha, for component A and in the range from 5 to 250 g of AS/ha, preferably 5 to 100 g of AS/ha for component B.

The generally used application rate ratios of components A:B are given below and refer to the weight ratio of components A:B relative to one another. The weight ratio of components A and B relative to one another is here generally 1:100-100:1, preferably 1:25-25:1, particularly preferably 2:1 to 20:1.

For the application of the active ingredients of the herbicide combinations according to the invention in plant crops, it may be expedient, depending on the plant crop, to apply a safener above certain application rates in order to reduce or to avoid possible damage to the crop plant. Such safeners are known to the person skilled in the art. Particularly highly suitable safeners are fenchlorazole-ethyl (S1), mefenpyr-diethyl (S2), isoxadifen-ethyl (S3), cyprosulfamide (S4), cloquintocet-mexyl (S5), fenclorim (S6), dichlormid (S7), benoxacor (S8), furilazole (S9), oxabetrinil (S10), fluxofenim (S11), flurazole (S12) and naphthalic anhydride (S13).

Also encompassed according to the invention are those herbicide combinations which, besides components A and B, also comprise one or more further agrochemical active ingredients from the group of the insecticides, fungicides and safeners. For such combinations, the preferred conditions explained above apply. Of particular suitability are those herbicide combinations comprising a safener such as mefenpyr-diethyl (S2), isoxadifen-ethyl (S3), cyprosulfamide (S4) and cloquintocet-mexyl (S5).

Thus, besides the combinations according to the invention of diflufenican and metsulfuron-methyl/thifensulfuron-methyl/tribenuron-methyl already mentioned, the combinations of

diflufenican, metsulfuron-methyl and mefenpyr-diethyl,
diflufenican, metsulfuron-methyl and isoxadifen-ethyl,
diflufenican, metsulfuron-methyl and cyprosulfamide,
diflufenican, metsulfuron-methyl and cloquintocet-mexyl,
diflufenican, thifensulfuron-methyl and mefenpyr-diethyl,
diflufenican, thifensulfuron-methyl and isoxadifen-ethyl,
diflufenican, thifensulfuron-methyl and cyprosulfamide and
diflufenican, thifensulfuron-methyl and cloquintocet-mexyl,
are also particularly preferred.

The herbicide combinations according to the invention have excellent herbicidal efficacy against a broad spectrum of economically important mono- and dicotyledonous harmful plants. Perennial weeds which are difficult to control and which sprout from rhizomes, root stocks or other permanent organs are also readily controlled by the active ingredients. In this connection, it is immaterial whether the substances are applied in the presowing, pre-emergence or post-emergence method.

If the herbicide combinations according to the invention are applied to the soil surface prior to germination, then either the emergence of the weed seedlings is completely prevented or the weeds grow to the seed leaf stage, but then stop growing and finally die off completely after the course of three to four weeks. In the case of application of the active ingredients to the green parts of the plant in the post-emergence method, a drastic stop in growth likewise occurs very rapidly following treatment and the weed plants remain in the growth stage present at the time of application or die off altogether after a certain time, meaning that in this way a weed competition harmful for the crop plants is eliminated very early on and in a lasting manner.

The herbicide combinations according to the invention are characterized by a rapid-onset and long-lasting herbicide effect. The resistance to rain of the active ingredients in the combinations according to the invention is generally favorable. As a particular advantage, it is crucial that the dosages of components A and B that are effective and used in the combinations can be set so low that their soil effect is optimally low. Consequently, their use is not only possible for the first time in sensitive crops, but groundwater contaminations are practically avoided. The combination according to the invention of active ingredients makes it possible to considerably reduce the required application rate of the active ingredients.

In a preferred embodiment, superadditive (=synergistic) effects arise with the joint application of components A and B. Here, the effect in the combinations is greater than the expected sum of the effects of the individual herbicides used. The synergistic effects permit a reduction in the application rate, the control of a broader spectrum of weeds and weed grasses, a more rapid onset of the herbicidal effect, a longer action time, better control of the harmful plants with only one or a few applications and an extension of the possible application period. In some cases, the amount of harmful ingredients, such as nitrogen or oleic acid, and their entry into the soil is also reduced as a result of using the herbicide combinations.

Said properties and advantages are beneficial in the practical control of weeds for keeping agricultural crops free from undesired competing plants and thus for qualitatively and quantitatively ensuring and/or increasing the yields. The technical standard is clearly surpassed by these new combinations with regard to the described properties.

Although the herbicide combinations according to the invention have excellent herbicidal activity against mono- and dicotyledonous harmful plants, the crop plants are damaged only negligibly, if at all.

Moreover, the herbicide combinations according to the invention sometimes have excellent growth-regulatory properties in the crop plants. They intervene to regulate the plant's own metabolism and can therefore be used for the targeted influencing of plant ingredients and for ease of harvesting such as, for example, by triggering desiccation and stunted growth. Furthermore, they are also suitable for generally controlling and inhibiting undesired vegetative growth without killing off the plants at the same time. An inhibition of the vegetative growth plays a great role for many mono- and dicotyledonous crops since yield losses upon storage can hereby be reduced or completely prevented.

On account of their herbicidal and plant growth-regulatory properties, the herbicide combinations according to the invention can be used for controlling harmful plants in genetically modified crop plants or crop plants obtained by mutation selection. These crop plants are generally characterized by particularly advantageous properties, such as resistances to herbicides or resistances to plant diseases or pathogens of plant diseases such as certain insects or microorganisms such as fungi, bacteria or viruses. Other particular properties relate, for example, to the harvest material with regard to amount, quality, storability, composition and special ingredients. Thus, for example, transgenic plants with increased starch content or modified quality of the starch or those with another fatty acid composition of the harvest material are known. Conventional ways of producing new plants which have modified properties compared to existing plants hitherto consist, for example, in classic cultivation methods and the production of mutants (see e.g. U.S. Pat. No. 5,162,602; U.S. Pat. No. 4,761,373; U.S. Pat. No. 4,443,971). Alternatively new plants with modified properties can be produced using genetic engineering methods (see e.g. EP-A-0221044, EP-A-0131624). For example, in several cases the following have been described:
genetic modifications of crop plants for the purpose of modifying the starch synthesized in the plants (e.g. WO 92/11376, WO 92/14827, WO 91/19806),
transgenic crop plants which are resistant to other herbicides, for example to sulfonylureas (EP-A-0257993, U.S. Pat. No. 5,013,659),
transgenic crop plants with the ability to produce Bacillus thuringiensis toxins (Bt toxins) which make the plants resistant to certain pests (EP-A-0142924, EP-A-0193259),
transgenic crop plants with a modified fatty acid composition (WO 91/13972).

Numerous molecular biological techniques with which new transgenic plants with modified properties can be produced are known in principle; see e.g. Sambrook et al., 1989, Molecular Cloning, A Laboratory Manual, 2nd edition, Cold Spring Harbor Laboratory Press, Cold Spring Harbor, N.Y.; or Winnacker “Gene and Klone [Genes and Clones]”, VCH Weinheim, 2nd edition, 1996 or Christou, “Trends in Plant Science” 1 (1996) 423-431).

For genetic manipulations of this type, nucleic acid molecules can be introduced into plasmids which permit a mutagenesis or a sequence modification through recombination of DNA sequences. With the help of the aforementioned standard methods it is possible, for example, to undertake base exchanges, remove part sequences or add natural or synthetic sequences. To join the DNA fragments with one another, adapters or linkers can be attached to the fragments.

The production of plant cells with reduced activity of a gene product can be achieved, for example, through the expression of at least one corresponding antisense-RNA, of a sense-RNA for achieving a cosuppression effect or the expression of at least one correspondingly constructed ribozyme which specifically cleaves transcripts of the aforementioned gene product.

For this, firstly DNA molecules can be used which include the entire coding sequence of a gene product including any flanking sequences present, and also DNA molecules which only include parts of the coding sequence, in which case it is necessary for these parts to be long enough to bring about an antisense effect in the cells. It is also possible to use DNA sequences which have a high degree of homology to the coding sequences of a gene product, but are not completely identical.

During the expression of nucleic acid molecules in plants, the synthesized protein can be localized in any desired compartment of the plant cell. However, in order to achieve localization in a specific compartment, the coding region can, for example, be linked to DNA sequences which ensure the localization in a specific compartment. Sequences of this type are known to the person skilled in the art (see, for example, Braun et al., EMBO J. 11 (1992), 3219-3227; Wolter et al., Proc. Natl. Acad. Sci. USA 85 (1988), 846-850; Sonnewald et al., Plant J. 1 (1991), 95-106).

The transgenic plant cells can be regenerated by known techniques to give whole plants. The transgenic plants may in principle be plants of any desired plant species, i.e. both monocotyledonous and also dicotyledonous plants. Thus, transgenic plants are obtainable which have modified properties through overexpression, suppression or inhibition of homologous (=natural) genes or gene sequences or expression of heterologous (=foreign) genes or gene sequences.

Furthermore, the present invention also provides a method for controlling undesired plant growth (e.g. harmful plants), preferably in plant crops such as cereals (e.g. wheat, barley, rye, oats, hybrids thereof such as triticale, rice, corn, millet), sugar beet, sugar cane, rape, cotton and soybean, particularly preferably in monocotyledonous crops such as cereals, e.g. wheat, barley, rye, oats, hybrids thereof such as triticale, rice, corn and millet, where one or more herbicides of type A are applied with one or more herbicides of type B and, if appropriate, one or more herbicides of type C or of a safener together or separately, e.g. in pre-emergence, post-emergence or in pre- and post-emergence, to the plants, e.g. harmful plants, plant parts, plant seeds or the area on which the plants grow, e.g. the habitat.

The plant crops can also be genetically modified or obtained by mutation selection and are preferably tolerant to acetolactate synthase (ALS) inhibitors.

The invention also provides the use of the herbicide combinations according to the invention for controlling harmful plants, preferably in plant crops.

The herbicide combinations according to the invention can also be used non-selectively for controlling undesired plant growth, e.g. in plantation crops, on roadsides, squares, industrial plants or railway installations.

The herbicide combinations according to the invention can be in the form either of mixed formulations of components A and B and, if appropriate, with further agrochemical active ingredients, additives and/or customary formulation auxiliaries, which are then used diluted with water in the customary manner, or are prepared as so-called tank mixtures through joint dilution of the separately formulated or partially separately formulated components with water.

Components A and B or combinations thereof can be formulated in different ways depending on which biological and/or chemical-physical parameters are prescribed. Suitable general formulation options are, for example: spray powders (WP), water-soluble concentrates, emulsifiable concentrates (EC), aqueous solutions (SL), emulsions (EW), such as oil-in-water and water-in-oil emulsions, sprayable solutions or emulsions, suspension concentrates (SC), dispersions based on oil or water, suspoemulsions, dusting agents (DP), seed dressings, granules for scattering and soil application or water-dispersible granules (WG), ULV formulations, microcapsules or waxes.

The individual formulation types are known in principle and are described, for example, in: Winnacker-Küchler, “Chemische Technologie [Chemical Technology]”, volume 7, C. Hauser Verlag Munich, 4th edition, 1986; van Valkenburg, “Pesticide Formulations”, Marcel Dekker N.Y., 1973; K. Martens, “Spray Drying Handbook”, 3rd Ed. 1979, G. Goodwin Ltd. London.

The necessary formulation auxiliaries such as inert materials, surfactants, solvents and further additives are likewise known and are described, for example, in: Watkins, “Handbook of Insecticide Dust Diluents and Carriers”, 2nd Ed., Darland Books, Caldwell N.J.; H. v. Olphen, “Introduction to Clay Colloid Chemistry”; 2nd Ed., J. Wiley & Sons, N.Y. Marsden, “Solvents Guide”, 2nd Ed., Interscience, N.Y. 1950; McCutcheon's, “Detergents and Emulsifiers Annual”, MC Publ. Corp., Ridegewood N.J.; Sisley and Wood, “Encyclopedia of Surface Active Agents”, Chem. Publ. Co. Inc., N.Y. 1964; Schönfeldt, “Grenzflächenaktive Äthylenoxidaddukte [Surface-active ethylene oxide adducts]”, Wiss. Verlagsgesellschaft, Stuttgart 1976, Winnacker-Küchler, “Chemische Technologie [Chemical Technology]”, volume 7, C. Hauser Verlag Munich, 4th edition, 1986.

On the basis of these formulations, it is also possible to prepare combinations with other agrochemical active ingredients, such as fungicides, insecticides, and also safeners, fertilizers and/or growth regulators, e.g. in the form of a ready mix or as tank mix.

Spray powders (wettable powders) are preparations which can be dispersed uniformly in water and which comprise, besides the active ingredient, apart from a diluent or inert substance, also surfactants of ionic or nonionic type (wetting agents, dispersants), e.g. polyoxethylated alkylphenols, polyethoxylated fatty alcohols or polyethoxylated fatty amines, alkanesulfonates or alkylbenzenesulfonates, sodium lignosulfonate, sodium 2,2′-dinaphthylmethane-6,6′-disulfonate, sodium dibutyl-naphthalenesulfonate and also sodium oleoylmethyltaurate.

Emulsifiable concentrates are prepared by dissolving the active ingredient in an organic solvent, e.g. butanol, cyclohexanone, dimethylformamide, xylene or else higher-boiling aromatics or hydrocarbons with the addition of one or more ionic or nonionic surfactants (emulsifiers). Emulsifiers which can be used are, for example: alkylarylsulfonic calcium salts, such as Ca dodecylbenzenesulfonate, or nonionic emulsifiers, such as fatty acid polyglycol esters, alkylaryl polyglycol ethers, fatty alcohol polyglycol ethers, propylene oxide-ethylene oxide condensation products, alkyl polyethers, sorbitan fatty acid esters, polyoxyethylene sorbitan fatty acid esters or polyoxethylene sorbitol esters.

Dusting agents are obtained by grinding the active ingredient with finely divided solid substances, e.g. talc, natural clays, such as kaolin, bentonite or pyrophyllite, or diatomaceous earth.

Suspension concentrates (SC) may be water-based or oil-based. They can be produced, for example, by wet grinding by means of standard commercial bead mills and if appropriate addition of further surfactants, as have for example already been listed above in connection with the other types of formulation.

Emulsions, e.g. oil-in-water emulsions (EW), can be prepared, for example, by means of stirrers, colloid mills and/or static mixers using aqueous organic solvents and if appropriate further surfactants, as have for example already been listed above in connection with the other types of formulation.

Granules can be prepared either by atomizing the active ingredient onto granulated inert material that is capable of adsorption or by applying active ingredient concentrates by means of adhesives, e.g. polyvinyl alcohol, sodium polyacrylate or else mineral oils, onto the surface of carrier substances such as sand, kaolinites or of granulated inert material. Suitable active ingredients can also be granulated in the manner customary for producing fertilizer granules—if desired in a mixture with fertilizers.

Water-dispersible granules are usually prepared by customary methods such as spray-drying, fluidized-bed granulation, pan granulation, mixing with high-speed mixers and extrusion without solid inert material. For the preparation of pan, fluidized-bed, extruder and spray granules, see, for example, methods in “Spray-Drying Handbook” 3rd ed. 1979, G. Goodwin Ltd., London; J. E. Browning, “Agglomeration”, Chemical and Engineering 1967, pages 147 ff; “Perry's Chemical Engineer's Handbook”, 5th Ed., McGraw-Hill, New York 1973, pp. 8-57.

For further details relating to the formulation of crop protection compositions, see, for example, G. C. Klingman, “Weed Control as a Science”, John Wiley and Sons, Inc., New York, 1961, pages 81-96 and J. D. Freyer, S. A. Evans, “Weed Control Handbook”, 5th Ed., Blackwell Scientific Publications, Oxford, 1968, pages 101-103.

The agrochemical formulations generally comprise 0.1 to 99 percent by weight, in particular 2 to 95% by weight, of active ingredients of components A and/or B, the following concentrations being customary depending on the type of formulation: in spray powders, the active ingredient concentration is e.g. about 10 to 95% by weight, the remainder to 100% by weight consists of customary formulation constituents. In the case of emulsifiable concentrates, the active ingredient concentration can be e.g. 5 to 80% by weight. Dust-like formulations comprise in most cases 5 to 20% by weight of active ingredient, sprayable solutions about 0.2 to 25% by weight of active ingredient. In the case of granules, such as dispersible granules, the active ingredient content depends partly on whether the active compound is present in liquid or solid form and which granulation auxiliaries and fillers are used. As a rule, the content in the case of the water-dispersible granules is between 10 and 90% by weight.

In addition, the specified active ingredient formulations optionally comprise the adhesives, wetting agents, dispersants, emulsifiers, preservatives, antifreezes and solvents, fillers, colorants and carriers, antifoams, evaporation inhibitors and agents which influence the pH or the viscosity that are customary in each case.

The herbicidal effect of the herbicide combinations according to the invention can be improved, for example, by surface-active substances, preferably by wetting agents from the series of fatty alcohol polyglycol ethers. The fatty alcohol polyglycol ethers preferably comprise 10-18 carbon atoms in the fatty alcohol radical and 2-20 ethylene oxide units in the polyglycol ether moiety. The fatty alcohol polyglycol ethers may be present in nonionic form, or ionic form, e.g. in the form of fatty alcohol polyglycol ether sulfates, which are used, for example, as alkali metal salts (e.g. sodium and potassium salts) or ammonium salts, or else as alkaline earth metal salts, such as magnesium salts, such as C₁₂/C₁₄-fatty alcohol diglycol ether sulfate sodium (Genapol® LRO, Clariant GmbH); see e.g. EP-A-0476555, EP-A-0048436, EP-A-0336151 or U.S. Pat. No. 4,400,196 and Proc. EWRS Symp. “Factors Affecting Herbicidal Activity and Selectivity”, 227-232 (1988). Nonionic fatty alcohol polyglycol ethers are for example (C₁₀-C₁₈)-, preferably (C₁₀-C₁₄)-fatty alcohol polyglycol ethers containing 2-20, preferably 3-15, ethylene oxide units (e.g. isotridecyl alcohol polyglycol ether) e.g. from the Genapol® X series such as Genapol® X-030, Genapol® X-060, Genapol® X-080 or Genapol® X-150 (all from Clariant GmbH).

The present invention further encompasses the combination of components A and B with the aforementioned wetting agents from the series of the fatty alcohol polyglycol ethers which preferably contain 10-18 carbon atoms in the fatty alcohol radical and 2-20 ethylene oxide units in the polyglycol ether moiety and may be present in nonionic or ionic form (e.g. as fatty alcohol polyglycol ether sulfates). Preference is given to C₁₂/C₁₄-fatty alcohol diglycol ether sulfate sodium (Genapol® LRO, Clariant GmbH) and isotridecyl alcohol polyglycol ether, with 3-15 ethylene oxide units, e.g. from the Genapol® X series such as Genapol® X-030, Genapol® X-060, Genapol® X-080 and Genapol® X-150 (all from Clariant GmbH). Furthermore, it is known that fatty alcohol polyglycol ethers such as nonionic or ionic fatty alcohol polyglycol ethers (e.g. fatty alcohol polyglycol ether sulfates) are also suitable as penetration auxiliaries and effect boosters for a series of other herbicides, inter alia also for herbicides from the imidazolinone series (see e.g. EP-A-0502014).

Furthermore, it is known that fatty alcohol polyglycol ethers such as nonionic or ionic fatty alcohol polyglycol ethers (e.g. fatty alcohol polyglycol ether sulfates) are also suitable as penetration auxiliaries and effect boosters for a series of other herbicides, inter alia also for herbicides from the imidazolinone series (see e.g. EP-A-0502014).

The herbicidal effect of the herbicide combinations according to the invention can also be enhanced through the use of vegetable oils. The term vegetable oils is understood as meaning oils from oil-supplying vegetable species such as soybean oil, rapeseed oil, corn oil, sunflower oil, cotton seed oil, linseed oil, coconut oil, palm oil, safflower oil or ricinus oil, in particular rapeseed oil, and transesterification products thereof, e.g. alkyl esters such as rapeseed oil methyl ester or rapeseed oil ethyl ester.

The vegetable oils are preferably esters of C₁₀-C₂₂-, preferably C₁₂-C₂₀-fatty acids. The C₁₀-C₂₂-fatty acid esters are, for example, esters of unsaturated or saturated C₁₀-C₂₂-fatty acids, in particular with an even number of carbon atoms, e.g. erucic acid, lauric acid, palmitic acid and in particular C₁₈-fatty acids such as stearic acid, oleic acid, linoleic acid or linolenic acid.

Examples of C₁₀-C₂₂-fatty acid esters are esters which are obtained by reacting glycerol or glycol with the C₁₀-C₂₂-fatty acids, as are obtained, for example, in oils from oil-supplying vegetable species, or C₁-C₂₀-alkyl C₁₀-C₂₂-fatty acid esters, as can be obtained, for example, by transesterifying the aforementioned glycerol or glycol C₁₀-C₂₂-fatty acid esters with C₁-C₂₀-alcohols (e.g. methanol, ethanol, propanol or butanol). The transesterification can take place by known methods, as are described, for example, in Römpp Chemie Lexikon [Römpp chemistry lexicon], 9th edition, volume 2, page 1343, Thieme Verlag Stuttgart.

Preferred C₁-C₂₀-alkyl C₁₀-C₂₂-fatty acid esters are methyl esters, ethyl esters, propyl esters, butyl esters, 2-ethylhexyl esters and dodecyl esters. Preferred glycol and glycerol C₁₀-C₂₂-fatty acid esters are the uniform or mixed glycol esters and glycerol esters of C₁₀-C₂₂-fatty acids, in particular those fatty acids with an even number of carbon atoms, e.g. erucic acid, lauric acid, palmitic acid and in particular C₁₈-fatty acids such as stearic acid, oleic acid, linoleic acid or linolenic acid.

The vegetable oils may be present in the herbicide combinations according to the invention e.g. in the form of commercially available oil-containing formulation additives, in particular those based on rapeseed oil such as Hasten® (Victorian Chemical Company, Australia, called Hasten below, main constituent: rapeseed oil ethyl ester), Actirob®B (Novance, France, called ActirobB below, main constituent: rapeseed oil methyl ester), Rako-Binol® (Bayer AG, Germany, called Rako-Binol below, main constituent: rapeseed oil), Renol® (Stefes, Germany, called Renol below, vegetable oil constituent: rapeseed oil methyl ester) or Stefes Mero® (Stefes, Germany, called Mero below, main constituent: rapeseed oil methyl ester).

In a further embodiment, the present invention encompasses combinations of components A and B with the aforementioned vegetable oils such as rapeseed oil, preferably in the form of commercially available oil-containing formulation additives, in particular those based on rapeseed oil such as Hasten® (Victorian Chemical Company, Australia, called Hasten below, main constituent: rapeseed oil ethyl ester), Actirob®B (Novance, France, called ActirobB below, main constituent: rapeseed oil methyl ester), Rako-Binol® (Bayer AG, Germany, called Rako-Binol below, main constituent: rapeseed oil), Renol® (Stefes, Germany, called Renol below, vegetable oil constituent: rapeseed oil methyl ester) or Stefes Mero® (Stefes, Germany, called Mero below, main constituent: rapeseed oil methyl ester).

For use, the formulations present in standard commercial form are, if appropriate, diluted in the usual manner, e.g. in the case of spray powders, emulsifiable concentrates, dispersions and water-dispersible granules by means of water. Dust-like preparations, soil and scatter granules, and also sprayable solutions are usually no longer diluted with further inert substances prior to use.

The active ingredients can be applied to the plants, plant parts, plant seeds or the habitat (arable soil), preferably to the green plants and plant parts and, if appropriate, additionally to the arable soil. One application option is the joint application of the active ingredients in the form of tank mixtures, where the optimally formulated concentrated formulations of the individual active ingredients are mixed together in the tank with water and the resulting spray liquor is applied.

A combined herbicidal formulation of the herbicide combinations according to the invention of components A and B has the advantage of easier application because the amounts of the components have already been adjusted in the correct ratio relative to one another. Moreover, the auxiliaries in the formulation can be optimally tailored to one another.

### A. Formulation Examples of a General Type

a) A dusting composition is obtained by mixing 10 parts by weight of an active ingredient/active ingredient mixture and 90 parts by weight of talc as inert substance and comminuting in a crushing mill.
b) A readily water-dispersible, wettable powder is obtained by mixing 25 parts by weight of an active ingredient/active ingredient mixture, 64 parts by weight of kaolin-containing quartz as inert substance, 10 parts by weight of potassium lignosulfonate and 1 part by weight of sodium oleoylmethyltaurate as wetting agent and dispersant and grinding in a pin mill.
c) A readily water-dispersible dispersion concentrate is obtained by mixing 20 parts by weight of an active ingredient/active ingredient mixture with 6 parts by weight of alkylphenol polyglycol ether (7Triton® X 207), 3 parts by weight of isotridecanol polyglycol ether (8 EO) and 71 parts by weight of paraffinic mineral oil (boiling range e.g. ca. 255 to 277 EC) and grinding in an attrition ball mill to a fineness below 5 microns.
d) An emulsifiable concentrate is obtained from 15 parts by weight of an active ingredient/active ingredient mixture, 75 parts by weight of cyclohexanone as solvent and 10 parts by weight of oxethylated nonylphenol as emulsifier.
e) Water-dispersible granules are obtained by mixing
   75 parts by weight of an active ingredient/active ingredient mixture,
   10 parts by weight of calcium lignosulfonate,
   5 parts by weight of sodium lauryl sulfate,
   3 parts by weight of polyvinyl alcohol and
   7 parts by weight of kaolin,
   grinding on a pin mill and granulating the powder in a fluidized bed by spraying on water as granulation liquid.
f) Water-dispersible granules are also obtained by homogenizing and precomminuting
   25 parts by weight of an active ingredient/active ingredient mixture,
   5 parts by weight of sodium 2,2′-dinaphthylmethane-6,6′-disulfonate,
   2 parts by weight of sodium oleoylmethyltaurate,
   1 part by weight of polyvinyl alcohol,
   17 parts by weight of calcium carbonate and
   50 parts by weight of water
   on a colloid mill, then grinding on a bead mill and atomizing and drying the suspension obtained in this way in a spray tower by means of a one-component nozzle.

### B. Biological Examples

### Herbicidal Effect

The seeds or rhizome sections of typical harmful plants present in the ground were grown under natural field conditions. Treatment with the herbicide combinations according to the invention or with the individually applied components A and B was carried out after the emergence of the harmful plants and the crop plants generally in the 2- to 4-leaf stage. The application of the active ingredients or active ingredient combinations formulated as WG, WP or EC was carried out post-emergence. After 2 to 8 weeks, an optical assessment was made compared to an untreated comparison group. Here, it was found that the herbicide combinations according to the invention have a synergistic herbicidal effect against economically significant mono- and dicotyledonous harmful plants, i.e. that the herbicide combinations according to the invention in most cases have a higher, in some cases significantly higher, herbicidal effect than corresponds to the sum of the effects of the individual herbicides. Moreover, the herbicidal effects of the herbicide combinations according to the invention are above the expected values in accordance with Colby. By contrast, the crop plants were undamaged or only negligibly damaged by the treatment.

If the observed effect values of the mixtures already exceed the formal sum of the values for the experiments with individual applications, then they likewise exceed the expected value in accordance with Colby, which is calculated according to the following formula (cf. S. R. Colby; in Weeds 15 (1967) pp. 20 to 22):

$$E = A + B - \frac{A \times B}{100}$$

Here:
A, B=in each case effect of component A or B, respectively, in percent at a dose of a or b grams of ai/ha, respectively.
E=expected value in % at a dose of a+b grams of ai/ha.

The observed values of the herbicide combinations according to the invention are above the expected values according to Colby.

1. A herbicide combination comprising, as sole herbicidal active ingredients,
A) diflufenican (component A), and
B) a herbicide from the group consisting of metsulfuron-methyl, thifensulfuron-methyl and tribenuron-methyl (component B).

2. The herbicide combination as claimed in claim 1, comprising diflufenican and metsulfuron-methyl.

3. The herbicide combination as claimed in claim 1, comprising diflufenican and thifensulfuron-methyl.

4. The herbicide combination as claimed in claim 1, comprising diflufenican and tribenuron-methyl.

5. The herbicide combination as claimed in claim 1, wherein the weight ratio of components A and B relative to one another is 2:1-100:1.

6. The herbicide combination as claimed in claim 5, wherein the weight ratio of components A and B relative to one another is 2:1 to 20:1.

7. The herbicide combination as claimed in claim 1, additionally comprising additives and/or formulation auxiliaries that are customary in crop protection.

8. The herbicide combination as claimed in claim 1, additionally comprising one or more further components from the group of agrochemical active ingredients comprising insecticides, fungicides and safeners.

9. The herbicide combination as claimed in claim 8, comprising a safener.

10. A method for controlling undesired plant growth, wherein components A and B in the herbicide combination, defined as in claim 1, are applied together or separately to the plants, plant parts, plant seeds or the area on which the plants grow.

11. The method as claimed in claim 10 for selectively controlling harmful plants in plant crops.

12. The method as claimed in claim 11 for controlling harmful plants in monocotyledonous plant crops.

13. The method as claimed in claim 12, wherein the plant crops have been genetically modified or obtained by mutation selection.
